(19) United States
(12) Patent Application Publication
(10) Pub. No.: US 2007/0179747 A1
(43) Pub. Date: Aug. 2, 2007

(54) SYSTEMS AND METHODS FOR SCHEDULING MACHINES FOR INSPECTION

(75) Inventors: Matthew Allen Nelson, Gardnerville, NV (US); Naresh Sundaram Iyer, Clifton Park, NY (US); John Erik Hershey, Ballston Lake, NY (US); Charles Erklin Seeley, Niskayuna, NY (US); Piero Patrone Bonissone, Schenectady, NY (US); Kai Frank Goebel, Ballston Lake, NY (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/307,335

(22) Filed: Feb. 1, 2006

(51) Int. Cl. G06F 15/00

(52) U.S. Cl. 702/185

(57) ABSTRACT

Systems and methods for determining the inspection schedule of a plurality of machines based on at least one operating condition including a monitoring system for determining at least one operating condition for a plurality of machines and a microprocessor programmed to analyze the at least one operating condition to identify whether a machine is unhealthy based on the analysis of at least one operating condition monitored and programmed to determine an optimal schedule for inspecting the plurality of machines using a PDC device.

### TECHNICAL FIELD

This invention relates to systems and methods for monitoring machines and more particularly relates to systems and methods for scheduling machines for inspection.

### BACKGROUND OF THE INVENTION

Factories, warehouses, and other facilities typically employ various types of machines for the manufacture or distribution of products. Because such machinery generally includes parts in motion, vibrations are generated from an individual machine and transmitted to the machine housing. Excessive vibration or vibrational modes of a particular character may indicate an unhealthy machine that may be in need of repair. Thus, it is common to monitor the vibration of a machine to prevent possible damage.

In order to determine the magnitude and nature of the vibration, transducers may be attached to, or placed in contact with, the machine housing so as to monitor the vibration. Subsequent analysis of the vibrational information determined by the transducers may provide valuable diagnostic data relating to the health of the monitored machinery. However, to monitor all machines, a transducer must be attached at every location in which monitoring of the vibration is desired. The health of the individual transducer also must be further monitored to ensure that the transducer is properly operating. In a facility employing thousands of machines, the purchase, installation, maintenance, and repair of thousands of transducers can become excessively expensive.

Alternatively, portable data collector (“PDC”) devices may be used to monitor the health of the monitored machinery. The PDC's are mobile devices that include a transducer and recording means to monitor the health of the machines. The PDC is transported to a machine and the transducer is placed in contact with the housing of the machine. The PDC can then record the vibrations of the housing. These recordings are subsequently analyzed in an attempt to assess the health of the machine. Operators must personally visit each machine and operate the PDC to record the vibrational information. The PDC operator may, therefore, spend an exorbitant amount of time monitoring the machines.

Therefore, there is a need in the art for systems and methods for determining an inspection schedule for PDC operators to allow them to optimally inspect machines that are unhealthy prior to inspection of healthy machines.

### SUMMARY OF INVENTION

According to one embodiment of the invention, an inspection schedule of a plurality of machines may be determined based on at least one operating condition including a monitoring system for determining at least one operating condition for a plurality of machines, and a microprocessor programmed to analyze the at least one operating condition to identify whether a machine is unhealthy based on the analysis of at least one operating condition monitored. The microprocessor may be programmed to determine an optimal schedule for inspecting the plurality of machines using a PDC device based on the analysis of the at least one operating condition. The operating condition may include a vibration of at least one machine. In one aspect of the invention, the microprocessor analyzes the at least one operating condition based on changes in the magnitude of the operating condition over time and may include vibration. The microprocessor may identify a machine as exhibiting incipient progressive degeneration when the change in magnitude of the operating condition exceeds a predetermined threshold.

According to another aspect of the invention, the microprocessor determines an optimal schedule based on a parameter selected from the group consisting of the location of the machine, the type of machine, and the proximity of the machine to incipient progressive degeneration. The monitoring system may include a remote monitoring system. The optimal schedule may be determined based on location of the machines determined to be unhealthy. The optimal schedule may further be determined based on the model of the machines.

Another embodiment of the invention includes a method for determining an inspection schedule for a plurality of machines based on operating conditions of the plurality of machines. The method includes providing a monitoring system for determining at least one operating condition for a plurality of machines in a facility, analyzing the operating condition using a microprocessor to determine whether a machine is exhibiting incipient progressive degeneration, and determining the schedule for inspecting the plurality machines using an inspection device. According to an aspect of the invention, a machine may be designated as unhealthy when the machine is exhibiting incipient progressive degeneration.

In another aspect of the invention, the inspection schedule for the plurality of machines may include inspecting machines determined to be unhealthy machines before inspecting machines determined to be healthy. The inspection schedule for the plurality of machines may be based on the location of the unhealthy machines or model of the unhealthy machines.

In another embodiment of the invention, an inspection schedule of a plurality of machines may be determined based on vibration of the plurality of machines with at least one reflective patch affixed to each of the plurality of machines. The vibration detection unit includes an optics module and a control module such that the optics module transmits an interrogator beam to the respective reflective patch of a plurality of machines and the reflective patch reflects a vibration modulated beam to the vibration detection unit. The optics module of the vibration detection unit demodulates the interrogator beam to determine the vibration of the machine. A microprocessor may be programmed to analyze the vibration of the plurality of machines to identify whether a machine is exhibiting incipient progressive degeneration based on the vibration of the plurality of machines. The microprocessor is programmed to determine an optimal schedule for inspecting the plurality of machines using a PDC device based on the analysis of the vibration of the plurality of machines.

### BRIEF DESCRIPTION OF THE DRAWINGS

Having thus described the invention in general terms, reference will now be made to the accompanying drawings, which are not necessarily drawn to scale, and wherein:

FIG. 1a illustrates the system of remote monitoring of vibration information from a machine according to an embodiment of this invention.

FIG. 1b illustrates the system of remote monitoring of vibration information from a machine with an optics module affixed to a movable system on the ceiling according to an aspect of this invention.

FIG. 1c illustrates the system of remote monitoring of vibration information from a machine with an optics module affixed to a movable system on the floor according to an aspect of this invention.

FIG. 2 illustrates the re-routing of an interrogator beam around an obstacle according to an aspect of this invention.

FIG. 3 illustrates a communication relationship between the vibration detection unit and a remote service facility according to an aspect of this invention.

FIG. 4 illustrates a flow chart for determining an inspection schedule according to an aspect of the invention.

FIG. 5 illustrates a an exemplary embodiment of an inspection schedule for a ten machine facility according to an aspect of this invention.

FIG. 6 illustrates a communication relationship between a computational facility and a remote analysis facility according to an aspect of the invention.

### DETAILED DESCRIPTION OF INVENTION

The present invention now will be described more fully hereinafter with reference to the accompanying drawings, in which exemplary embodiments of the invention are shown. This invention may, however, be embodied in many different forms and should not be construed as being limited to the embodiments set forth herein; rather, these embodiments are provided so that this disclosure will be thorough and complete, and will convey the scope of the invention to those skilled in the art.

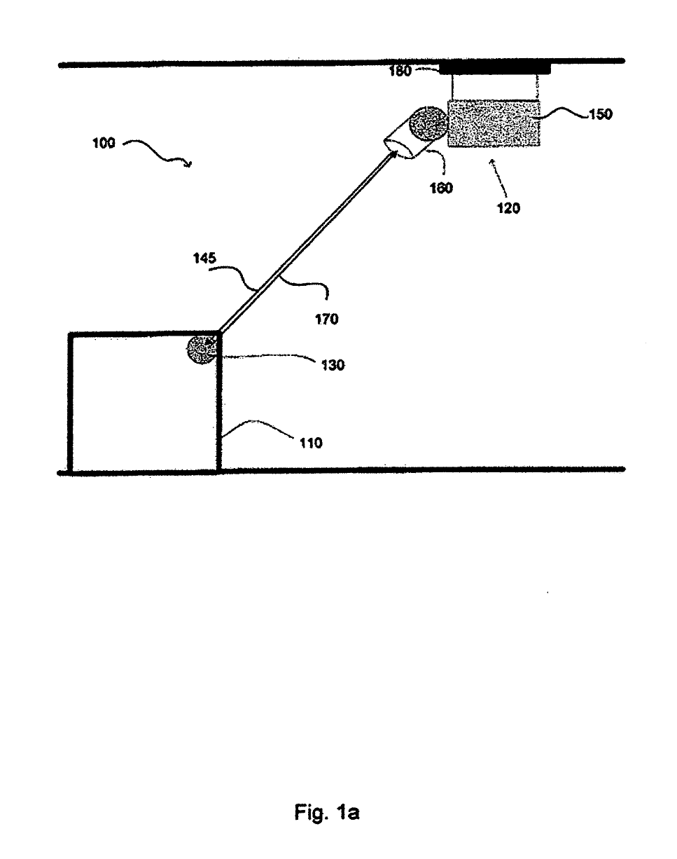

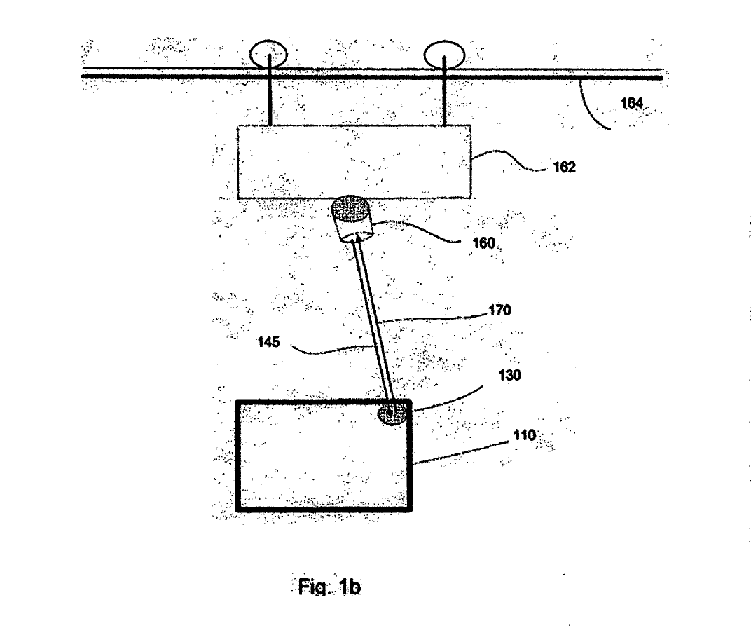

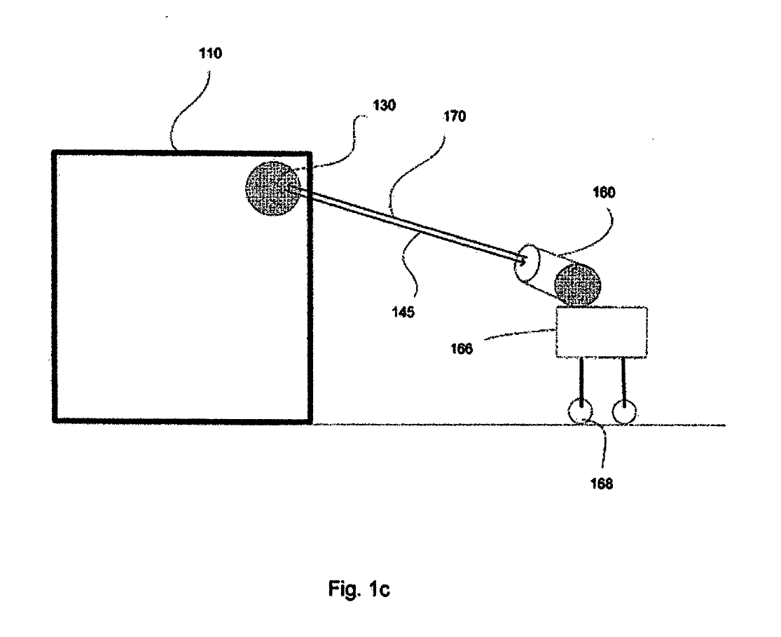

FIG. 1a illustrates a remote monitoring system 100 for the remote monitoring of the vibrations of a machine 110. The embodiment of FIG. 1a may be included in a factory, warehouse, or any other facility that requires the use of machinery. The remote monitoring system 100 may include a vibration detection unit 120 and a reflective patch 130. The vibration detection unit 120 may include a control module 150 and an optics module 160 that emits an interrogator beam 145. The control module may include a general purpose computer, special purpose computer, microprocessor, other programmable data processing apparatus, or a computer-readable memory that can direct a computer or other programmable data processing apparatus to function in accordance with this invention.

The interrogator beam 145 may be an electromagnetic beam. The electromagnetic beam may be a laser beam or any other suitable energy beam that can be used to detect vibrations of a machine. In an exemplary embodiment, the optics module 160 is a vibrometer manufactured by Polytec, Inc. of Tustin, Calif. One of ordinary skill in the art will appreciate that the optics module 160 may be any device or system of devices operable for the transmission and reception of an interrogator beam.

The vibration detection unit 120 may be located in any location in which it is operable to monitor the vibration of a machine. In an exemplary embodiment, the vibration detection unit 120 is attached to a structural frame of a facility ceiling. In another embodiment, the vibration detection unit 120 may be mounted on a movable system positioned to allow the optics module 160 to emit the electromagnetic beam to a desired location. FIGS. 1b and 1c illustrate exemplary embodiments of the optics module 160 affixed to a movable system to allow the optics module 160 to interrogate machines positioned at various locations in a facility. As shown in FIG. 1b, the optics module 160 may be affixed to a train 162 located about the ceiling of the facility. The train 162 may interface a track 164 at or near the ceiling of the facility. The train 162 may move in relation to the track 164 so that the train may be positioned with respect to any desired machine or sets of machines. The train 162 may be moved about the track either manually or electronically guided. As shown in FIG. 1c, the optics module 160 may be affixed to a mobile cart 166 that may move about the floor of the facility. The mobile cart 166 may interface the floor directly or may interface a track (not shown). In the exemplary embodiment of FIG. 1c, the mobile cart 166 includes casters 168 to allow the mobile cart 166 to roll about the floor. The mobile cart 166 may be moved either manually or electronically guided.

The optics module 160 may be oriented about one or more rotational and/or translational degrees of freedom. One of ordinary skill in the art will appreciate that any number of angular degrees of freedom are contemplated herein. The optics module 160 may be adjustable to control characteristics of the emitted interrogator beam 145, including but not limited to adjustment of the focal length, power, and multiplicity of beams. The adjustments may be performed electromechanically under the control of a software program or manually by an operator. The control module 150 controls the beam pointing direction of the optics module 160 and other adjustments to the optics module 160 such as the focal length of the emitted interrogator beam 145. The control module 150 may also receive external commands respecting the operation of the optics module 160 and the control module 150 may also report out the demodulated vibration data to an external or remote analysis facility. The optics module may be rotated to direct the interrogator beam at a reflective target on a substantially stationary surface to perform a diagnostic check for vibration of the optics module.

The reflective patch 130 of the remote monitoring system 100 may be affixed to the machine 110. The reflective patch 130 may be affixed at any location on the machine 110. A plurality of reflective patches also may be affixed to the machine in a number of locations on the machine for use in monitoring vibrations of different components or locations of the machine.

The reflective patch 130 may be a retro reflective patch that receives the interrogator beam at a normal or non-normal angle of incidence and reflects the interrogator beam 145 along the same or similar angle of incidence. In an exemplary embodiment, the reflective patch 130 is operable to reflect an interrogator beam 145 that is tens of degrees off-axis to a vector normal to the reflective patch 130 surface. In an exemplary embodiment, the reflective patch 130 is a retro reflective tape. The retro reflective tape may be easily affixed to a machine and allows a beam to be reflected at the same or similar angle of incidence as the incoming beam. The retro reflective tape of the exemplary embodiment may be commercially available tape, including but not limited to reflective tape sold by Reflexite Americas of New Britian, Conn., or tape designed and manufactured specifically for use in this invention. In another embodiment, the reflective patch 130 includes at least one corner cube reflector. One of ordinary skill in the art will appreciate that any reflective patch may be employed to reflect a beam along the same or similar angle of incidence of the transmitted beam, including but not limited to a mirror or other types of retro reflective tape.

The optics module 160 may transmit the interrogator beam 145 towards the reflective patch 130 affixed to the machine 110. The interrogator beam 145 travels to the reflective patch 130 affixed to the housing of the monitored machine 110. The reflective patch 130 receives the interrogator beam 145 and reflects the interrogator beam as a vibration modulated beam 170. The vibration modulated beam 170 returns to the optics module 160 along the same or similar path as the interrogator beam 145. Due to the vibration of the machine and in turn the vibration of the reflective patch affixed thereto, the vibration modulated beam 170 will carry the vibration information of the machine 110.

In order to determine the vibration of the machine, the vibration modulated beam 170 is demodulated in the optics module 160 and the machine vibrational data is recovered. The optics module 160 may also include an optical filter to filter out ambient radiation that is outside of the very narrowband spectral range of the vibration modulated beam 170. Demodulation of the vibration modulated beam is well-understood by persons skilled in the art and a person of ordinary skill in the art will appreciate that any appropriate method or system may be employed to demodulate the vibration modulated beam to determine the vibrational information contained therein, including Doppler shift demodulation.

The vibration detection unit 120 may further include a vibration isolation unit 180 that mitigates structural borne vibrations from interfering with the vibrational data embedded in the vibration modulated beam 170. The vibration isolation unit 180 may be installed between the vibration detection unit 120 and its host structure. Vibration isolation units are well known in the art and are commercially available. They are based on one or a combination of multiple technologies including, but not limited to, spring and beam column isolators, air bladders, and viscoelastic damping materials.

The components of the vibration detection unit may be integrated into one system or may include separate components. In an exemplary embodiment, the optics module 160 and the control module 150 are separate components that are mounted together in a facility. In another embodiment, the optics module 160 and the control module 150 are an integrated system. In yet another embodiment, the components of the vibration detection unit reside in different locations. For example, the optics module 160 may be located in a room containing the machine to be monitored and the control module 150 may be located in a separate room or completely separate location than the facility.

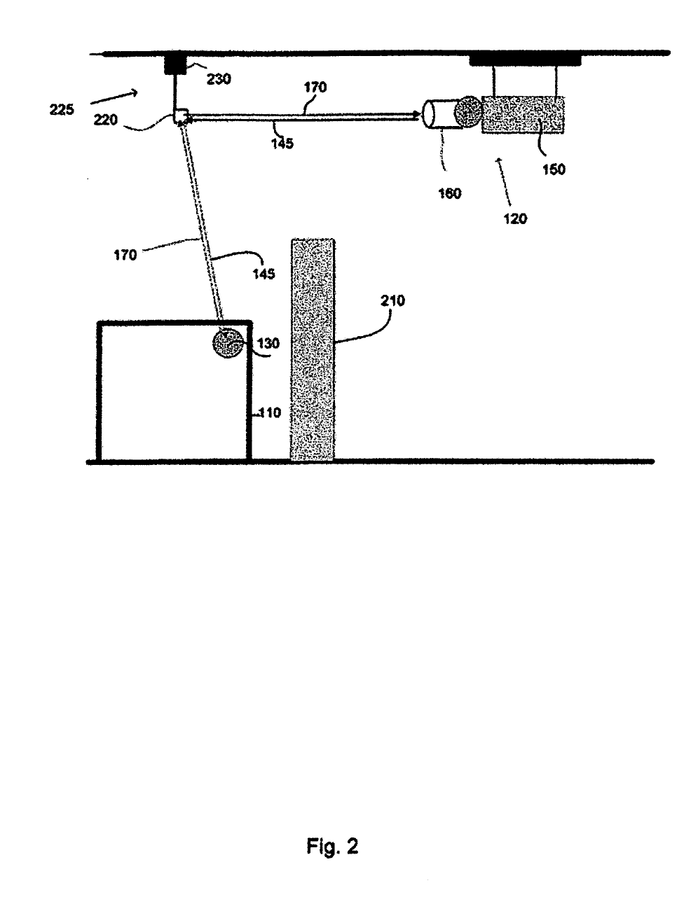

As illustrated in the embodiment of FIG. 2, the vibration detection unit 120 may be used to monitor the vibration of each of a plurality of machines 110. A reflective patch 130 may be affixed to the number of machines to be monitored. The angular and translational pointing position of the optics module 160 may be controlled through a software control system resident in the control module 150 or manually controlled through electromechanical controls. The optics module 160 may be rotated about a number of angles to align the interrogator beam with the reflective patch of a monitored machine. In another embodiment, the optics module 160 may further be mounted on at least one track (not shown) to allow the optics module 160 to translate linearly with respect to the number of machines to optimize the incidence angle of the interrogator beam 145 onto the reflective patch 130 of the monitored machine. One of ordinary skill in the art will appreciate that any means for positioning the optics module 160 such that it can transmit an interrogator beam 145 to the reflective patch 130 is contemplated herein.

In a factory or other location, the path between the optics module 160 and the reflective patch 130 affixed on a machine may be obstructed. FIG. 2 illustrates a situation in which an obstruction 210 blocks the interrogator beam 145 from being transmitted in a straight line from the optics module 160 to the reflective patch 130. A beam reflector 220 may be used to reflect the interrogator beam around the obstruction. The beam reflector 220 may be aligned so that the interrogator beam 145 is redirected from the optics module 160 to the reflective patch 130. The beam reflector 220 may be affixed in any location proximate to the reflective patch 130 and the optics module 160. In an exemplary embodiment, the beam reflector 220 is attached to a structural frame such as a factory ceiling using an attachment unit 225. The attachment unit 225 may include a beam reflector vibration isolation unit 230. The beam reflector 220 also may include a remotely controlled rotator unit to change the angles of incidence and reflection of the interrogator beam 145 in order to monitor a number of machines. One of ordinary skill in the art will appreciate that any system that allows the interrogator beam to be re-directed around an obstruction to the reflective patch 130 is contemplated herein.

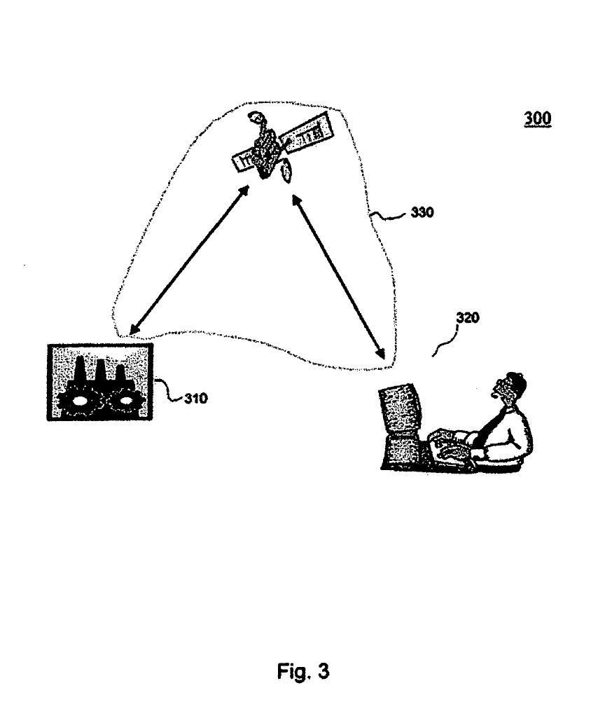

FIG. 3 illustrates a two-way communications link 330 between a facility 310 housing the plurality of monitored machines and a remote analysis facility 320. The remote analysis facility 320 may be used to analyze the vibration data to determine strategies for resolving the vibrational concerns related to the machines. The communications link 330 may be satellite-based, fiber-optic, land-based, radio, wire-line, the Internet, or any other data transport facility. The remote analysis facility 320 may include any processor-driven device, such as a personal computer, laptop computer, handheld computer and the like which may further include a memory, input/output (“I/O”) interface(s) and a network interface. The memory may store data files and various computer executable programs, such as an operating system (“OS”) and a data analysis program.

The remote analysis facility 320 may analyze the vibrational data from one or a number of machines from at least one facility using the data analysis program. The data analysis program may include a statistical analysis of the vibrational data. In one embodiment, the remote analysis facility may determine statistical information relating to a particular model or manufacturer of machines in a number of facilities. In another embodiment, the remote analysis facility may determine statistical information on all machines in one particular facility. One of ordinary skill in the art will appreciate that this invention is not limited to the aforementioned statistical analyses but may be any statistical analysis relating to the plurality of machines.

### SCHEDULING PDC MONITORING

Analysis of the operating conditions of a plurality of machines may be used to more efficiently schedule further inspection, monitoring, maintenance, or repair of the machinery. The health of a machine may be determined through analysis of any operating condition including vibration, temperature, and pressure. A PDC device 530 may be used to monitor operating conditions of the plurality of machines. PDC operators 520 can transport the PDC device 530 to a machine and contact the PDC device 530 to the machine to inspect its operating conditions. To ensure that the operator contacts the PDC device 530 to machines that need inspection, an inspection schedule may be determined to direct operators to unhealthy or potentially unhealthy machines through the use of a monitoring system. In an exemplary embodiment, the remote monitoring system 100 may be used as the monitoring system to determine the health of a plurality of machines which may be used to create a schedule that the operators should follow to better optimize the inspection of machines. For illustration purposes, the remote monitoring system 100 will be used to describe the determination of the inspection schedule. Furthermore, the illustrations will focus on the use of vibrational data to schedule maintenance of the machines. One of ordinary skill in the art will appreciate that any system or method may be used to monitor the health of a plurality of machines and any operating condition including but not limited to vibration, temperature, and pressure may be used in this invention to determine the inspection schedule.

The systems and methods of determining an inspection schedule may be generated using computer program instructions which may be loaded onto a general purpose computer, special purpose computer, microprocessor, or other programmable data processing apparatus. These computer program instructions also may be stored in a computer-readable memory that can direct a computer or other programmable data processing apparatus to function in a particular manner, such that the instructions stored in the computer-readable memory produce an article of manufacture including instruction means that implement the functions of this invention. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions of this invention.

In an exemplary embodiment, vibration information obtained from the remote monitoring system may be used to determine whether a machine is unhealthy. A machine may be unhealthy if it exhibits incipient progressive degeneration or any other abnormal operating condition. Methods of determining whether a machine is exhibiting incipient progressive degeneration are known in the art and may be based on factors such as the frequency, magnitude, or change in magnitude of the vibrations of the machine. A machine may be exhibiting incipient progressive degeneration when bearings within the machine begin to degenerate which may be characterized by subtle deformations forming in the bearings, micro-cracks appearing below the surface of the bearings, spalling occuring on the surface including spalling that is not visible, expected changes occurring in the vibration signatures and/or amplitudes in the ultrasonic frequency range, or any other degenerative characteristic. Any method for determining a machine's proximity to progressive degeneration based on the vibration information obtained from the machine is contemplated herein.

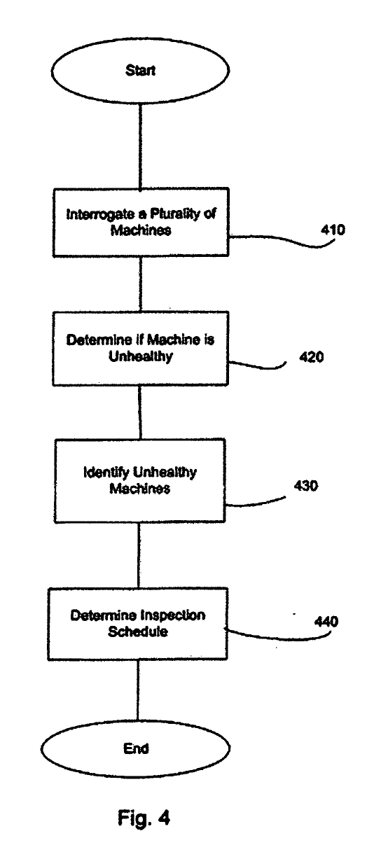

FIG. 4 illustrates a method of monitoring an operating condition of a plurality of machines to determine a more efficient schedule for PDC monitoring. In the exemplary embodiment of FIG. 4, the remote monitoring system interrogates a plurality of machines in a given facility to monitor changes in operating conditions, at step 410. For example, if the operating condition monitored changes over time, the machine may be exhibiting incipient progressive degeneration as shown in step 420. At step 430, a plurality of machines exhibiting incipient progressive degeneration are identified as unhealthy. In an exemplary embodiment, a computer program used to identify unhealthy machines sets a flag to identify which machine requires increased monitoring. One of ordinary skill in the art will appreciate that any method of identifying machines exhibiting incipient progressive degeneration is contemplated and is not limited to the setting of flags in software programs.

From the determination of which machines are exhibiting incipient progressive degeneration, an inspection schedule may be created at step 440 to optimize the inspection of the plurality of machines to gain productivity and to further track or prevent the deterioration of unhealthy machines. The inspection schedule allows the operators expertise to be focused on unhealthy machines and preserves the valuable time and resources typically wasted by PDC operators analyzing healthy machines. Determination of the inspection schedule may be based on the location of the machines, type of machine, proximity of the machine to incipient progressive degeneration, or any other relevant factor. Any schedule that optimizes the operators inspection of the plurality of machines in a facility to allow the PDC operators to focus on the unhealthy machines is contemplated herein.

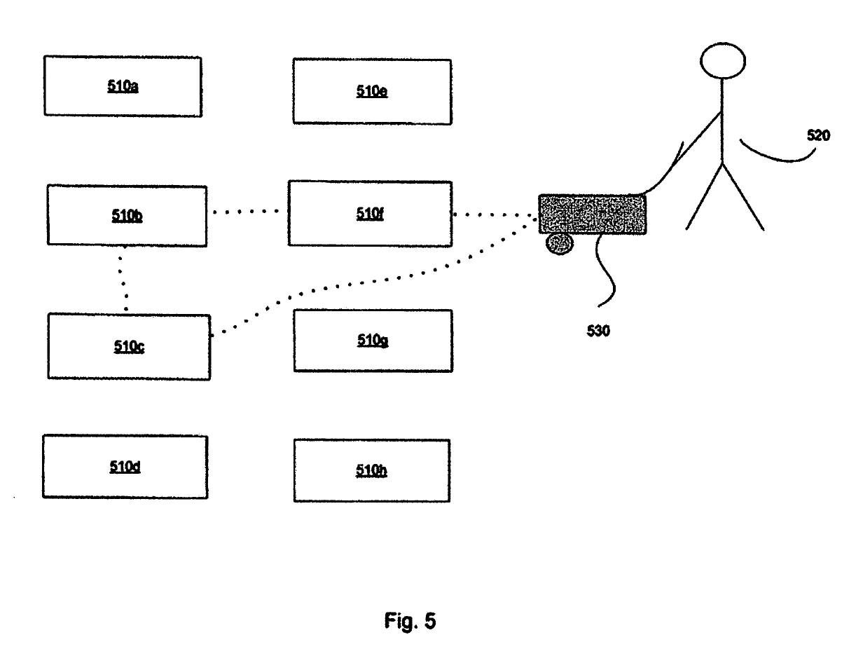

FIG. 5 illustrates an exemplary embodiment of the determination of the inspection schedule optimized to inspect the plurality of machines. In this example, a facility includes eight machines 510a-510h. Without determination of the inspection schedule, a PDC operator 520 would inspect every machine in order beginning with 510a and ending with 510h with the PDC device 530. However, the inspection schedule may be created to optimize the inspections by the PDC operator 520. The vibrations of the plurality of machines may be monitored using the remote monitoring system 100. The change in vibrations of the plurality of machines is further analyzed to determine if any machines are exhibiting incipient progressive degeneration. In this example, machines 510b, 510c, and 510f exhibit significant increases in vibration and are determined to be unhealthy machines. The inspection schedule may be determined such that the PDC operator only inspects the unhealthy machines and does so in an optimal manner. In this example, the inspection schedule may be determined such that the PDC operator inspects machines in the order of 510b, 510c, and then 510f. This order of inspection for example optimizes the PDC operators inspection of the machine by factoring in the location of the unhealthy machines. However, any inspection schedule may be created that optimizes the PDC inspectors efforts to inspect machines determined to be unhealthy.

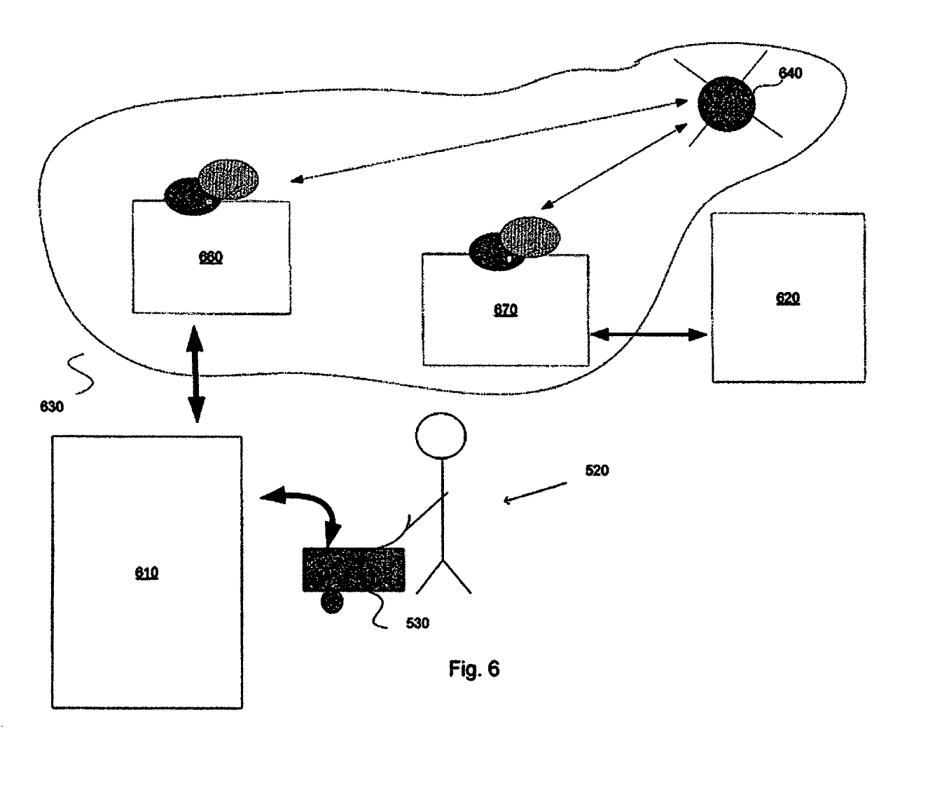

As shown in the exemplary embodiment of FIG. 6, an analysis of the data collected by the PDC devices 530 may be performed either on the plant premises in a computational facility 610 or in a remote analysis facility 620. The analysis may include a further determination of whether a machine is exhibiting incipient progressive degeneration based on factors such as the frequency, magnitude, or change in magnitude of the operating conditions determined by the PDC operator. In an exemplary embodiment, the connection between the computational facility 610 may be a two-way communications link 630 that may include a satellite 640, a computational facility satellite terminal 660 directly connected to the computational facility 610, and a remote analysis facility satellite terminal 670 directly connected to the remote analysis facility 620. The two-way communications link 630 is not limited to satellite systems but may include fiber-optic, land-based, radio, wire-line, Internet, or any other data transport means.

In the exemplary embodiment of FIG. 6, the inspection schedule may be modified based on the analysis of the data collected by the PDC devices at the remote facility 620. Instructions to modify the inspection schedule may be passed from the remote analysis facility 620 through the two-way communications link 630 to the computational facility 610. The remote analysis facility 620 may provide the computational facility 610 of new analytical instructions or algorithms for analyzing the PDC-collected data.

The inspection scheduling system also may be used to analyze whether a particular type of machine has common problems. For example, a plurality of machines in a plurality of facilities may be monitored using at least one remote monitoring system in each facility. In each facility, the respective remote monitoring system may inspect the machines in the facility and determine the health of each machine based on its operating conditions. The health information may be transmitted to a remote analysis facility 620 to determine health trends in common types of machines. The machine trends may relate to manufacturers and models of machines. From this information, it can be determined whether a particular type of machine has common failures and whether those types of machines should be monitored more frequently to prevent progressive degeneration.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in generic and descriptive sense only and not for purposes of limitation.

1-12. (canceled)

13. A method for determining an inspection schedule for a plurality of machines based on operating conditions of the plurality of machines comprising:
providing a monitoring system for determining at least one operating condition for a plurality of machines in a facility, wherein the monitoring system comprises
at least one retro reflective patch affixed to each of the plurality of machines;
a vibration detection unit comprising an optics module, wherein the optics module transmits an interrogator beam to the at least one retro reflective patch of a plurality of machines and the at least one retro reflective patch reflects a vibration modulated beam to the vibration detection unit, wherein the optics module of the vibration detection unit demodulates the interrogator beam to determine the vibration of the machine;
a microprocessor programmed to analyze the vibrations of the plurality of machines to identify whether a machine is unhealthy based on the vibrations of the plurality of machines, wherein the microprocessor is programmed to determine an optimal schedule for inspecting the plurality of machines using a portable data collector device based on the analysis of the vibrations of the plurality of machines;
analyzing the operating condition using the microprocessor to determine whether a machine is unhealthy; and
determining the schedule for inspecting the plurality machines using an inspection device.

14. The method of claim 13 further comprising designating a machine as unhealthy when the machine is exhibiting incipient progressive degeneration.

15. The method of claim 14, wherein the inspection schedule for the plurality of machines comprises inspecting machines determined to be unhealthy machines before inspecting machines determined to be healthy.

16. The method of claim 15, wherein the inspection schedule for the plurality of machines comprises inspecting machines based on the location of the unhealthy machines.

17. The method of claim 15, wherein the inspection schedule for the plurality of machines comprises inspecting machines based on the model of the unhealthy machines.

18. A system for determining the inspection schedule of a plurality of machines based on vibrations of the plurality of machines comprising:
at least one retro reflective patch affixed to each of the plurality of machines;
a vibration detection unit comprising an optics module, wherein the optics module transmits an interrogator beam to the at least one retro reflective patch of a plurality of machines and the at least one retro reflective patch reflects a vibration modulated beam to the vibration detection unit, wherein the optics module of the vibration detection unit demodulates the interrogator beam to determine the vibration of the machine;
a microprocessor programmed to analyze the vibrations of the plurality of machines to identify whether a machine is unhealthy based on the vibrations of the plurality of machines, wherein the microprocessor is programmed to determine an optimal schedule for inspecting the plurality of machines using a portable data collector device based on the analysis of the vibrations of the plurality of machines.

19. The system of claim 18, wherein the operating condition is vibration of at least one machine.

20. The system of claim 18, wherein the microprocessor analyzes the at least one operating condition based on changes in the magnitude of the operating condition over time.

21. The system of claim 20, wherein the microprocessor analyzes the vibration of at least one machine based on changes in the magnitude of the vibration over time.

22. The system of claim 21, wherein the microprocessor identifies a machine as unhealthy when the change in magnitude of the operating condition exceeds a predetermined threshold.

23. The system of claim 18, wherein the microprocessor determines an optimal schedule based on a parameter selected from the group consisting of the location of the machine, the type of machine, and the proximity of the machine to progressive degeneration.

24. The system of claim 18, wherein the monitoring system comprises a remote monitoring system.

25. The system of claim 18, wherein the optimal schedule is determined based on location of the machines determined to be unhealthy.

26. The system of claim 18, wherein the optimal schedule is determined based on the health of the plurality of machines.

27. The system of claim 26, wherein the optimal schedule is further determined based on the location of the machines.

28. The system of claim 26, wherein the optimal schedule is further determined based on model of the machines.
